(19) United States
(12) Patent Application Publication
(10) Pub. No.: US 2011/0055797 A1
(43) Pub. Date: Mar. 3, 2011

(54) AUTOMATIC MONITOR GENERATION FROM QUANTITATIVE SCENARIO BASED REQUIREMENT SPECIFICATIONS

(75) Inventors: Ambar A. Gakdari, Bangalore (IN); Silky Arora, Bangalore (IN); Ramesh Sethu, Bangalore (IN)

(73) Assignee: GM GLOBAL TECHNOLOGY OPERATIONS, INC., Detroit, MI (US)

(21) Appl. No.: 12/548,261

(22) Filed: Aug. 26, 2009

(51) Int. Cl. G06F 9/44

(52) U.S. Cl. 717/100

(57) ABSTRACT

A method for validating a design model includes generating a requirement in the form of an event sequence chart with quantitative constraints and generating a monitor from the event sequence chart, wherein the monitor is configured to validate the design model with respect to the requirement.

### BACKGROUND

In general, a software development process (i.e., software life cycle) includes a requirements development stage, a modeling and functional verification stage, and a code development stage. A requirement may be characterized as a documented need of how a particular product or service should perform. More particularly, a requirement may be referred to as a statement that identifies a necessary attribute, capability, characteristic or quality of a system. Requirements in the form of a requirements specification are used as inputs into the design stages of a product development process to illustrate what elements and functions are necessary for a particular application.

Requirements can be expressed using a variety of different Specification languages supported by the requirements specification. Specification languages, which are often referred to as formalisms, may be graphical or textual in nature and may include, without limitation, transition systems (e.g., state machines), event sequence charts (e.g., scenario or sequence diagrams) and structured English programming. Scenario based requirements are configured to express event sequences and their interconnecting relationships. Thus, scenario based requirement specifications are often used for specifying the functional properties of a system.

In addition to functional requirements, there is a need to express non-functional quantitative properties in the specification such as the rate of occurrences of events, delay between the cause-effect event pairs, response times and periodicity.

In known systems, quantitative requirements are specified informally along with other functional requirements. The requirements are then checked in the design or implementation through manual testing. Thus, there is a need to formalize the specification of quantitative requirements and automate the process of validating them during simulations.

### SUMMARY

A method for validating a design model includes generating a requirement in the form of an event sequence chart with quantitative constraints and generating a monitor from the event sequence chart, wherein the monitor is configured to validate the design model with respect to the requirement.

Additional features will become apparent from the following description and appended claims, taken in conjunction with the accompanying drawings.

### BRIEF DESCRIPTION OF THE DRAWINGS

FIG. 1 illustrates an exemplary system for monitor synthesis;

FIG. 2 illustrates an exemplary event sequence chart with quantitative constraints, according to an embodiment;

FIG. 3 illustrates an exemplary Stateflow monitor; and

FIG. 4 illustrates an exemplary monitor-based design validation system, according to an embodiment.

### DETAILED DESCRIPTION OF THE EMBODIMENTS

The embodiments described herein relate generally to a system and method for validating a design model and, more particularly, to a method for automatically generating a Stateflow monitor from a quantitative scenario-based requirements specification to validate the design model. The system includes a formalism (i.e., design language) for expressing quantitative constraints over scenarios specified using a visual notation. The language, referred to as ESC-QC (Event Sequence Charts with Quantitative Constraints), has formal syntax and semantics based on timed event traces. The system also includes an algorithm for automatic generation of simulation monitors configured to detect violations with respect to the scenario specification. The monitors are expressed in a Stateflow language and designed to work in the simulation environment along with the design models.

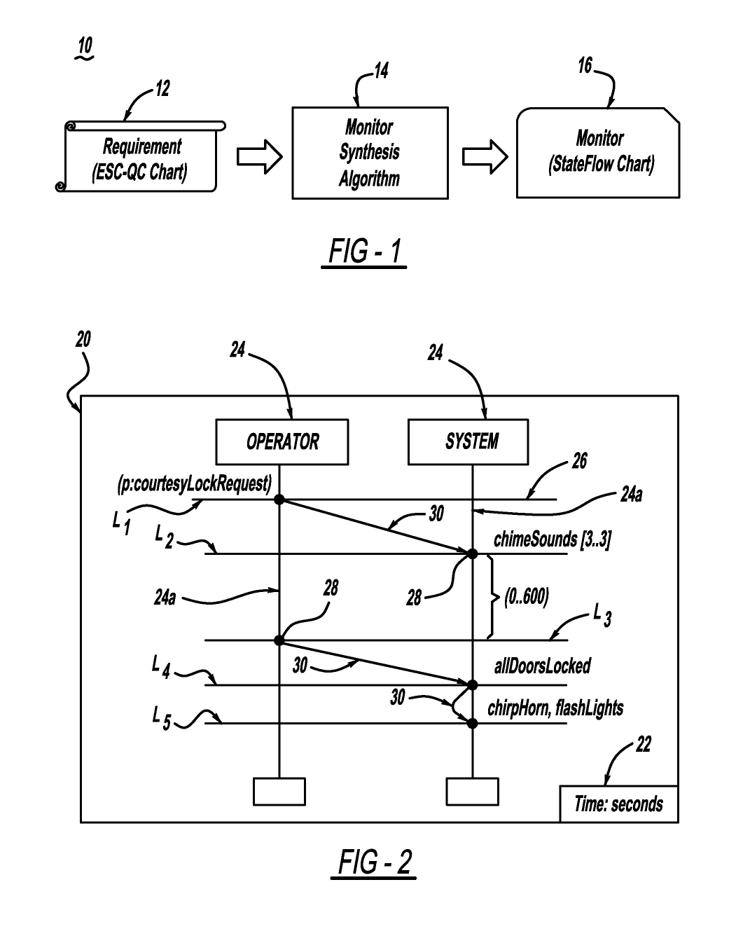

FIG. 1 illustrates an exemplary monitor synthesis system 10 configured to translate a specification requirement into a Stateflow monitor. The requirements 12 are modeled as an event sequence chart in ESC-QC notation, which is a scenario-based visual specification language for expressing quantitative constraints commonly used in specifying embedded control systems.

FIG. 2 shows an exemplary ESC-QC chart illustrating a requirement with quantitative constraints for an automotive body control system. The rectangular box 20 surrounding the ESC-QC chart represents a finite scenario. The time units 22 are specified in the bottom right corner, which in this example is seconds. Each scenario is modeled as a event sequence chart that includes agents, events (independent or conditioned) and the causal relation between events. The agents 24 are represented in the chart by vertical lines 24a and are the interacting instances in the requirement under consideration. The chart for this requirement involves two agents; an operator and the system (e.g., a vehicle entry control system).

Each event in a scenario is associated with a observation point (denoted by the horizontal lines 26). The time increases vertically downwards. Events on the same horizontal line 26 occur simultaneously. The horizontal lines 26 in an ESC-QC chart symbolize points of observation of the system. The visual order (i.e., top to bottom) between the lines is indicative of the order in which the system is observed. Thus, all the events lying on the same line are said to have occurred together. The lines also have an order number or label associated with them, which refers to the order amongst them. In the example shown in FIG. 2, there are five observation points labeled L₁-L₅.

Events 28 are an occurrence of interest in the system and are shown at the intersection of the agent (on which it occurs) and the horizontal line (marking the order of its occurrence). The general form of an event is p: e, meaning, condition p implies occurrence of event e. Absence of an explicit condition is taken as true: e. A repeat annotation on an event captures its multiple occurrences. In the example shown in FIG. 2 the event “chime” repeats thrice.

A cause-effect relation relates two events as one is a cause of the other. It is shown by an arrow 30 from the source to the target. In other words, the occurrence of the target implies the occurrence of the source in the past. For instance, in the example shown in FIG. 2, the “chime” is caused by the “LockRequest.”

While the horizontal lines 26 indicate order in which the events are observed, a delay annotation specifies the minimum and maximum delay allowed between events on respective lines. Visually, the curly brackets between two horizontal lines (e.g., L₂ and L₃ in FIG. 2), along with the annotation of the form (x . . . y), where x and y are natural numbers, says that the delay between the occurrence of all events on line L₂ and all events on line L₃ is no less than x and no more than y. The box 22 in the right hand bottom corner of the chart indicates the unit of delay.

As briefly mentioned above, a repeat annotation can be associated with the events. Its visual syntax is e[a . . . b], where “a” and “b” are natural numbers and e is an event. The annotation means that event e repeats at least “a” times and at most “b” times. The event e is synchronized on its first occurrence with other synchronous events (i.e., events that appear on the same horizontal line as e in the chart) that are specified, possibly on other agents. In the case of a causal relationship between events with repeat annotation, the last occurrence of the source event is said to cause the first occurrence of the target event.

Turning now to the specific scenario described by the ESC-QC chart shown in FIG. 2, the requirement details an interaction between the system and an operator when closing the door of an automobile. The requirement includes the following criteria.

### Preconditions:

1) At least one door is open;
2) The key is not in the ignition; and
3) The last door closed locking (LDCL) feature is enabled.

### Events:

1) The operator issues a courtesy lock request from the open door;
2) The system issues a chime sound three times;
3) The operator closes all doors within ten minutes;
4) The system locks all doors five seconds after the last door is closed; and
5) Upon locking, an audible horn chirp and visual light flash occurs to let the operator know the command has been executed.

Thus, in sum, the above requirement describes an interaction between the system and operator wherein the system acknowledges a courtesy lock request by the operator by giving a chime sound three times. The system then waits ten minutes (600 seconds) for the operator to close all doors, and after five seconds, it locks all doors and notifies the operator on the completion of the request.

Referring again to FIG. 1, the monitor synthesis system 10 further includes a computing device 14 configured to implement an algorithm that generates a Stateflow monitor 16 from the requirements 12 modeled by the ESC-QC chart shown in FIG. 2. The computing device 14 generally includes applications, which may be software applications tangibly embodied as a set of computer-executable instructions on a computer readable medium within computing device 14. Computing device 14 may be any one of a number of computing devices, such as a personal computer, handheld computing device, etc. Although only one computing device 14 is shown in FIG. 1 for ease of illustration, the system 10 may include multiple computing devices 14, external or internal.

Computing devices generally each include instructions executable by one or more devices such as those listed above. Computer-executable instructions may be compiled or interpreted from computer programs created using a variety of programming languages and/or technologies, including without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable media includes any medium that participates in providing data (e.g., instructions), which may be read by a computer. Such a medium may take many forms, including, but not limited to, non-volatile media, volatile media, and transmission media. Non-volatile media includes, for example, optical or magnetic disks and other persistent memory. Volatile media include dynamic random access memory (DRAM), which typically constitutes a main memory. Common forms of computer-readable media include any medium from which a computer can read.

One embodiment of the algorithm and related subroutines implemented on computing device 14 are illustrated below.

Algorithm 1: Monitor Synthesis Algorithm

```
Data: ESC-QC Chart C
Result: Monitor in Stateflow
Draw a state; Name it INIT;
forall l ∈ getLabels(C) do
  Draw Stateₗ;
  forall trg ∈ getAllTriggersOnlabel (l, C) do
    From State_{l′} to Stateₗ and transition on trg where
    l′is the greatest label which is smaller than l;
  end
end
forall evt = (e, l, [x..y])in E do
  Add entry action in state Stateₗ en: entry_{(e,l)}=Timer;
  Add a self loop on Stateₗ triggered on event(e);
  Add transition action no_of _occurenceₑᵥₑₙₜ₍ₑ₎++ on
  every incoming transition of event(e) to Stateₗ;
  forall t ∈ all outgoing transitions from Stateₗ do
    if t is triggered by event(e) then
      Add the condition
      no_of _occurenceₑᵥₑₙₜ₍ₑ₎ ≦ y in the guard of t;
    else
      Add the condition
      x ≦ no_of _occurenceₑᵥₑₙₜ₍ₑ₎ ≦ y in the guard
      of t;
    end
  end
  Add transition from state Stateₗ to state INIT on
  condition no_of _occurenceₑᵥₑₙₜ₍ₑ₎ > y;
end
forall δ = ((e,l,[x..y]),(e′,l′,[x′..y′]),(d₁,d₂) ∈ Δ do
    Assume l ≦ l′;
    Add the condition d₁ ≦ δ_{e,e′} ≦ d₂ in the guard of
    every outgoing transition from state State_{l′};
    Add transition from state State_{l′} to State INIT on
    condition δ_{e,e′} < d₁||δ_{e,e′} > d₂;
end
    forall cr = ((e,l,[x..y]),(e′,l′,[x′..y′]),(d₁,d₂) ∈ CR) do
    On all incoming transitions to state Stateₗ which have
    event(e) in their guard, add transition action
    flagₑ = TRUE;
    On all incoming transition to state State_{l′} which have
    event(e′) in their guard, and condition flagₑ = TRUE
    in their guard;
end
```

Algorithm 2: Procedure: getLabels

```
Data: ESC-QC Chart: C
Result: Set of labels: lbs
lbs ← φ;
forall (e,l,[x..y]) ∈ E do
  if l ∉ lbs then
    Add l to lbs;
  else
  end
end
```

Algorithm 3: Procedure: getAllTriggersOnLabel

```
Data: ESC-QC Chart: C
Data: Label : l ′1’
Result: Set of guards: G
  events ← {(e,l,[x..y])|l == l′};
G ←all possible combinations such that for all
  (e,l,[x..y]) ∈ events either event(e) or [cond(e) ==FALSE]
is chosen;
```

The ESC-QC chart implemented in the example above defines a finite set of agents (A), a finite set of propositional symbols (Prop), a finite set of alphabet of events/event names (Σₑᵥₜ), and an ordered finite set of labels L={l₁, l₂ . . . lₖ} where kεN and l₁<l₂< . . . <lₖ infinite set of annotations ( [symbol] ) of the form [x . . . y] where x, yεN. The ESC-QC chart C is defined by [symbol] E, Δ, CR [symbol] where,
1) E={(e, l, [x . . . y])|eε(Prop×Σₑᵥₜ×A), lεL and [x . . . y]ε [symbol] } is a set of labeled events.
2)Δ={(e₁, e₂, (d . . . d′))|e₁, e₂εE and d, d′εN} is a set of Delay annotations.
3) CR={(e₁, e₂)|e₁, e₂εE} is a set of cause-effect relationships.
   Additionally, event: E→Σₑᵥₜ; cond: E→Prop; agent: E→A. The abstract syntax for the requirements specified above with respect to FIG. 2 are as follows.

### A={Operator, System}

Σₑᵥₜ={LockReq, chime, allDoorsClosed, allDoorsLocked, HornandLights}
Prop=precond
R={[x . . . y]|x, yεN}
L={l₁, l₂, l₃, l₄, l₅}
The chart C={E, Δ, CR} where,
E={(LockedReq, precond, l₁, [1 . . . 1]), (chime, True, l₂, [3 . . . 3]), allDoorsClosed, true, l₃, [1 . . . 1])(allDoorsLocked, True, l₄, [1 . . . 1])} (HornAndLights, True, l₅, [1 . . . 1])
CR={[(LockedReq, precond, l₁, [1 . . . 1]), (chime, True, l₂, [3 . . . 3])], allDoorsClosed, true, l₃, [1 . . . 1]), (allDoorsLocked, True, l₄, [1 . . . 1])]}
Δ={[(chime, True, l₂, [3 . . . 3]), allDoorsClosed, true, l₃, [1 . . . 1]), (0 . . . 600)] allDoorsClosed, true, l₃, [1 . . . 1] (allDoorsLocked, True, l₄, [1 . . . 1]), (0 . . . 600)]}}

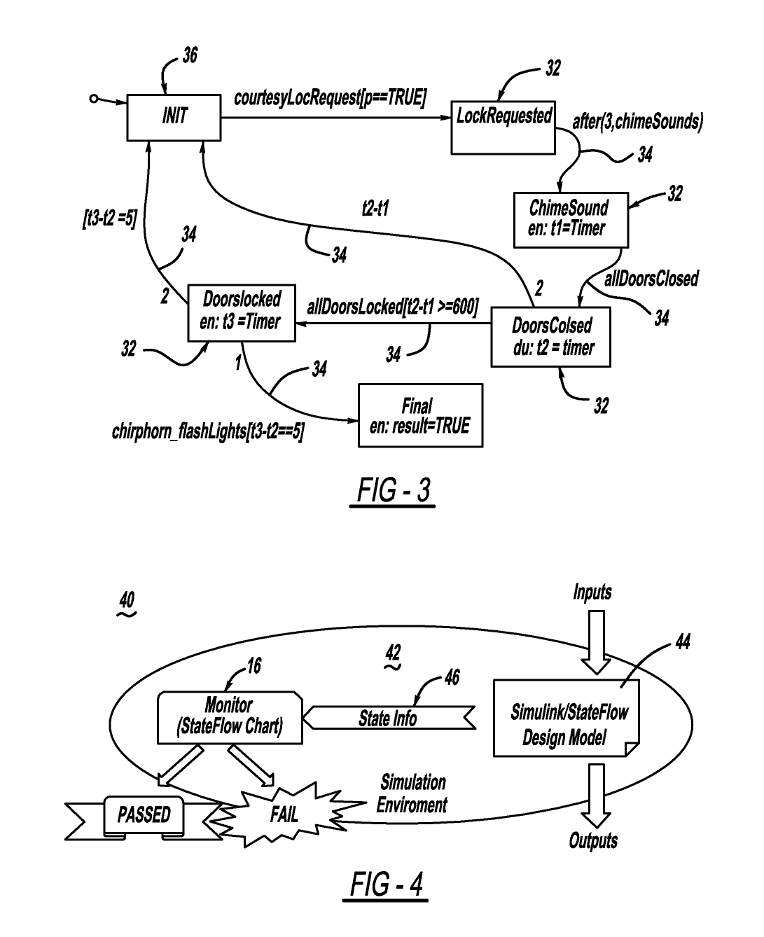

FIG. 3 illustrates an exemplary synthesized monitor 16 generated by the algorithm set forth above and according to the ESC-QC chart shown in FIG. 2. In one embodiment, the synthesized monitor 16 is a Stateflow chart comprising “and” states 32 with entry and exit actions. The transitions 32 between the states 30 are triggered on events from the requirements specification and have guarding conditions for various constraints from the specification (e.g., number of times an event occurs, the delay between horizontal lines or the cause effect relation between events). Each horizontal line (i.e. the events on it) in the chart reflects in the form of a state change in the monitor 16. Between two such lines, the monitor 16 remains in the same state. Thus, the monitor 16 has a state corresponding to each line.

The monitor 16 shown in FIG. 3 illustrates a state transition on occurrence of each event and checks for boolean as well as quantitative timing constraints before taking transitions. The annotation for repetition of events translates to the self loops on states in Stateflow, while the time delay is measured by registering the simulation time from a function timer. The last state is an accepting state and all others are non-accepting. There is no outgoing transition from the last accepting state, so once an accepting prefix is seen in a trace, the whole trace stands accepted. This is in accordance with the existential semantics of ESC-QC.

In addition, there is an INIT state 36 to represent the state when no interesting events or conditions have occurred. In one embodiment, the algorithm above is implemented using Java 1.5, however, one of ordinary skill in the art understands that the algorithm may be implemented using any other known suitable means.

FIG. 4 illustrates an exemplary monitor-based design validation system 40 having a simulation environment 42 configured to test and validate design models 44. In one embodiment, the simulation environment 42 is a numerical computing environment and programming language configured to perform tasks such as matrix manipulation, plotting of functions and data, implementation of algorithms, creation of user interfaces, and interfacing with programs in other languages. In one implementation, the simulation environment 42 also includes a graphical multi-domain simulation and model-based design for dynamic and embedded systems. In one non-limiting embodiment, the simulation environment 42 is Matlab™.

The synthesized monitors 16 are auto-generated outside the simulation environment 42 and configured to be “plugged into” the design models during simulation for design verification. The monitors 16 within the simulation environment 42 are used to determine if the design model conforms to the requirements specification, or if there are violations. A communication link 46 is established between the simulation of the design model 44 and the synthesized Stateflow monitors 16. The communication link 46 provides a continuous flow of information regarding the internal state of the design model to the monitors 16 during simulation. The monitors 16 continually read values (e.g., state of the variables) from the design model simulation and have logic to flag an error if it detects any anomaly with respect to the corresponding requirement. If at the end of the simulation no error is flagged, then the monitors indicate that the executed simulation up until that point is consistent with respect to the requirements.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A method for validating a design model, the method comprising the steps of:
generating a requirement in the form of an event sequence chart with quantitative constraints; and
generating a monitor from the event sequence chart, wherein the monitor is configured to validate the design model with respect to the requirement.

2. The method of claim 1, wherein validating the design model includes determining if there are errors in the design model relating to the quantitative constraints of the requirement.

3. The method of claim 1, wherein generating the monitor includes applying an algorithm configured to automatically generate the monitor.

4. The method of claim 1, further including executing the monitors in a simulation environment with the design model.

5. The method of claim 1, wherein the monitor is a Stateflow monitor configured to communicate with the design model in a simulation environment.

6. The method of claim 1, further including communicating state information between the monitor and the design model to detect errors with respect to a particular requirement.

7. A system comprising a computing device that includes an application configured to:
generate a requirement in the form of an event sequence chart with quantitative constraints; and
generate a monitor from the event sequence chart, wherein the monitor is configured to validate the design model with respect to the requirement.

8. The system of claim 7, wherein the monitor checks for Boolean and quantitative timing constraints in the design model with respect to a particular requirement.

9. The system of claim 7, wherein validating the design model includes determining if there are errors in the design model relating to the quantitative constraints of the requirement.

10. The system of claim 7, wherein generating the monitor includes applying an algorithm configured to automatically generate the monitor.

11. The system of claim 7, further including executing the monitors in a simulation environment with the design model.

12. The system of claim 7, wherein the monitor is a Stateflow monitor configured to communicate with the design model in a simulation environment.

13. The system of claim 7, further including communicating state information between the monitor and the design model to detect errors with respect to a particular requirement.

14. A computer-readable medium tangibly embodying computer-executable instructions for:
generating a requirement in the form of an event sequence chart with quantitative constraints; and
generating a monitor from the event sequence chart, wherein the monitor is configured to validate the design model with respect to the requirement.

15. The computer-readable medium of claim 14, wherein validating the design model includes determining if there are errors in the design model relating to the quantitative constraints of the requirement.

16. The computer-readable medium of claim 14, wherein generating the monitor includes applying an algorithm configured to automatically generate the monitor.

17. The computer-readable medium of claim 14, further including executing the monitors in a simulation environment with the design model.

18. The computer-readable medium of claim 14, wherein the monitor is a Stateflow monitor configured to communicate with the design model in a simulation environment.

19. The computer-readable medium of claim 14, further including communicating state information between the monitor and the design model to detect errors with respect to a particular requirement.
